(19) United States
(12) Patent Application Publication
(10) Pub. No.: US 2017/0317607 A1
(43) Pub. Date: Nov. 2, 2017

(54) THREE-LEVEL T-TYPE NPC POWER CONVERTER

(71) Applicant: Otis Elevator Company, Farmington, CT (US)

(72) Inventors: Ismail Agirman, Southington, CT (US); Steven M. Millett, Plainville, CT (US); Daryl J. Marvin, Farmington, CT (US); Shashank Krishnamurthy, Glastonbury, CT (US)

(21) Appl. No.: 15/520,471

(22) PCT Filed: Oct. 21, 2015
(86) PCT No.: PCT/US2015/056676

§ 371 Date: Apr. 20, 2017

Related U.S. Application Data
(60) Provisional application No. 62/067,003, filed on Oct. 22, 2014.

(51) Int. Cl. H02M 7/487; H02P 27/14; H02J 7/34

(52) U.S. Cl. CPC H02M 7/487; H02J 7/34; H02P 27/14

(57) ABSTRACT

A three-level converter includes a first converter leg having first switches connected across a positive DC node and a negative DC node, a second converter leg having second switches connected across the positive DC node and the negative DC node, and a third converter leg having third switches connected across the positive DC node the negative DC node. The converter includes a battery connected between the positive DC node and the negative DC node, and center-connected to a ground node having a ground potential. Each of the first, second, and third converter legs is connected to the ground node.

### BACKGROUND OF THE INVENTION

Three-phase motors are used in various industrial applications and devices. Elevator systems, for example, typically utilize three-phase AC voltage drives to power hoist motors that move the elevator cars. Because these hoist motors can consume large amounts of energy, energy efficient power control systems are desirable for use in such elevator systems.

In typical elevator systems, a building AC voltage source is supplied to a rectifier circuit where it is converted into a DC voltage. Inverters are then used to convert the DC voltage back into an AC voltage having desired characteristics. While inverters are well suited for such conversions, the resultant AC voltages typically contain various harmonic frequencies due to the power stage switching operations of the inverters. These harmonic frequencies are undesirable and can negatively affect the related elevator systems when present. The potential impact of harmonic frequencies can be estimated by considering the total harmonic distortion (THD) of a system, where the THD is a measure of the distortion that is present in a signal as it passes through the system. In general, systems with less THD are more desirable.

Three-phase two-level converters, known as six switch converters, are typically used in elevator systems. Because THD of conventional three-phase two-level converters without output filters is typically undesirable or unacceptable in most elevator system related applications, significant filtering is generally required in the source side in order to achieve an acceptable THD. Because such filtering requires the use of many additional passive components, filtering can often increase the size and cost of the associated inverter devices and elevator systems.

Additionally, typical three-phase two-level inverters also exhibit high dv/dt values (i.e., high transient voltages) and high switching losses. Continuous repetitive high transient voltages, when applied on the motor, can damage winding insulation (dielectric breakdown) and affect bearing life in a system. Higher switching losses due to higher switching voltages significantly reduces the efficiency of the drive system.

The use of multilevel inverters, such as diode-clamped, three-phase three-level inverters, has been proposed to overcome the deficiencies of three-phase two-level inverters. Conventional three-phase three-level inverters employ a large number of switches and diodes and are therefore overly complex and expensive.

### BRIEF DESCRIPTION OF THE INVENTION

According to one embodiment of the invention, a three-level converter includes a first converter leg having first switches, a second converter leg having second switches, and a third converter leg having third switches connected between a positive DC node and a negative DC node. The converter includes a battery connected between the positive DC node and the negative DC node, and center-connected to a ground node having a ground potential. Each of the first, second, and third converter legs is connected to the ground node.

In the above embodiment, or in the alternative, the three-level converter may include first and second capacitors connected in series between the positive DC node and the negative DC node, a connection of a cathode of the first capacitor and the anode of the second capacitor connected to the ground node.

In the above embodiments, or in the alternative, the first, second, and third converter legs may be arranged with one of a T-type neutral point clamped (T-NPC) and an advanced T-type neutral point clamped (AT-NPC) circuit topology.

In the above embodiments, or in the alternative, each of the first, second, and third converter legs may include first and second transistors connected in series, drain-to-source, between the positive DC node and the negative DC node, and an electrical connection between a drain of the first transistor and a source of the second transistor of each of the first, second, and third converter legs may define an AC voltage node.

In the above embodiments, or in the alternative, the first converter leg may include a first transistor and a second transistor connected in series, drain-to-source, between the positive DC node and the negative DC node, and an electrical connection between a drain of the first transistor and a source of the second transistor may define a first leg node. A third transistor may be connected in parallel, source-to-drain, with a fourth transistor, such that a first source-to-drain connection is connected to the ground node and a second source-to-drain connection is connected to the first leg node.

In the above embodiments, or in the alternative, the second converter leg may include a fifth transistor and a sixth transistor connected in series, drain-to-source, between the positive DC node and the negative DC node, and an electrical connection between a drain of the fifth transistor and a source of the sixth transistor may define a second leg node. A seventh transistor may be connected in parallel, source-to-drain, with an eighth transistor, such that a first source-to-drain connection is connected to the ground node and a second source-to-drain connection is connected to the second leg node. The third converter leg may include a ninth transistor and a tenth transistor connected in series, drain-to-source, between the positive DC node and the negative DC node, and an electrical connection between a drain of the ninth transistor and a source of the tenth transistor may define a third leg node. An eleventh transistor may be connected in parallel, source-to-drain, with a twelfth transistor, such that a first source-to-drain connection is connected to the ground node and a second source-to-drain connection is connected to the third leg node.

In the above embodiments, or in the alternative, the first converter leg may include a first transistor/diode pair including a third transistor connected in parallel, source-to-drain with a first diode, and a second transistor/diode pair including a fourth transistor connected in parallel, source-to-drain, with a second diode. The first transistor/diode pair may be connected in series with the second transistor/diode pair between the ground node and the first leg node.

In the above embodiments, or in the alternative, the second converter leg may include a fifth transistor and a sixth transistor connected in series, drain-to-source, between the positive DC node and the negative DC node, an electrical connection between a drain of the fifth transistor and a source of the sixth transistor defining a second leg node. A third transistor/diode pair may include a seventh transistor connected in parallel, source-to-drain with a third diode, and a fourth transistor/diode pair may include an eighth transistor connected in parallel, source-to-drain, with a fourth diode. The third transistor/diode pair may be connected in series with the fourth transistor/diode pair between the ground node and the second leg node. The third converter leg may include a ninth transistor and a tenth transistor connected in series, drain-to-source, between the positive DC node and the negative DC node, and an electrical connection between a drain of the ninth transistor and a source of the tenth transistor may define a third leg node. A fifth transistor/diode pair may include an eleventh transistor connected in parallel, source-to-drain with a fifth diode. A sixth transistor/diode pair may include a twelfth transistor connected in parallel, source-to-drain, with a sixth diode. The fifth transistor/diode pair may be connected in series with the sixth transistor/diode pair between the ground node and the third leg node.

In yet another embodiment, a power conversion system includes an AC power device configured to perform one of receiving AC power to operate the AC power device or generating AC power and a three-level converter connected to the AC power device. The three-level converter includes a first converter leg having first switches, a second converter leg having second switches, and a third converter leg having third switches connected between a positive DC node and a negative DC node. The converter includes a battery connected between the positive DC node and the negative DC node, and center-connected to a ground node having a ground potential. Each of the first, second, and third converter legs is connected to the ground node.

In the above embodiment, or in the alternative, the AC power device may be an AC motor that operates based on receiving AC power from the three-level converter.

In yet another embodiment, an elevator system includes an elevator car, a motor configured to move the elevator car, a battery for supplying power to the motor, and a three-level converter connected to the motor and the battery. The battery may be connected between the positive DC node and the negative DC node, and center-connected to a ground node having a ground potential. Each of the first, second, and third converter legs is connected to the ground node.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a power conversion system including a three-phase three-level converter according to an embodiment of the invention;

FIG. 2 is a schematic diagram of a power conversion system including a three-phase three-level converter according to another embodiment of the invention; and

FIG. 3 is an elevator system including a power conversion system according to an embodiment of the invention.

### DETAILED DESCRIPTION OF THE INVENTION

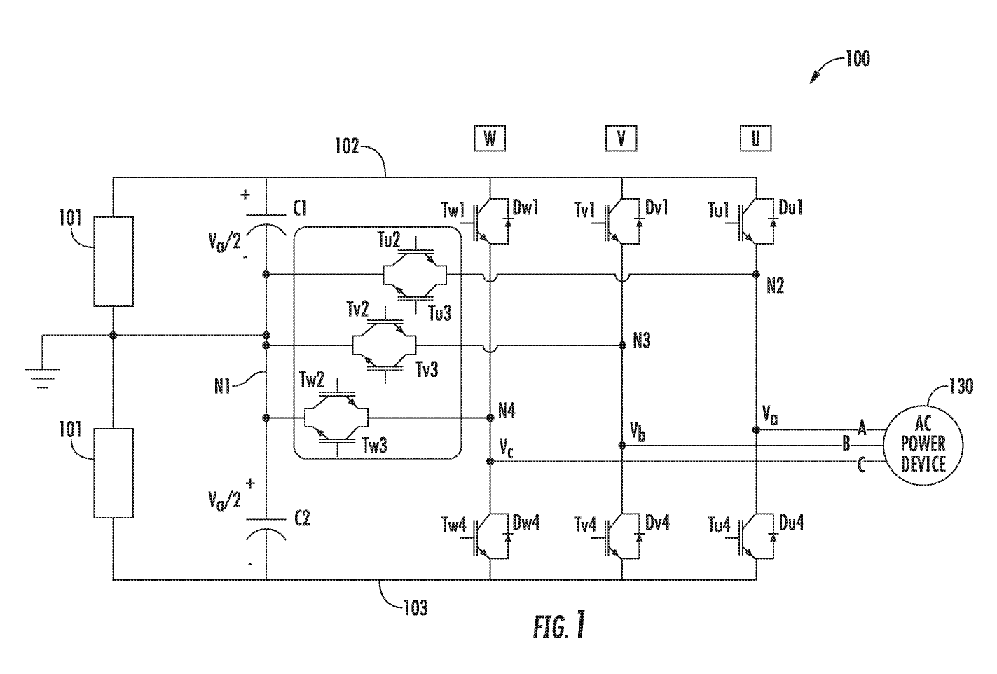

FIG. 1 is a schematic diagram of a power conversion system 100 according to an embodiment of the invention. The system 100 depicted in this embodiment uses a neutral point clamped (NPC) topology having three converter legs, indicated generally by reference letters U, V, and W. The system 100 depicted in this embodiment may be referred to as an advanced T-type neutral point clamped (AT-NPC) circuit. Switches Tu1, Tu2, Tu3, and Tu4 provide a first three-level converter leg (U), switches Tv1, Tv2, Tv3, and Tv4 provide a second three-level converter leg (V), and switches Tw1, Tw2, Tw3, and Tw4 provide a third three-level converter leg (W). In one embodiment, switches Tu1-Tu4, Tv1-Tv4, and Tw1-Tw4 are IGBTs, although MOSFETs, IGCT's, or other similar types of high-voltage switches may be utilized without departing from the scope of the invention.

When operating as an inverter, the three-level converter legs U, V, and W respectively provide AC power to AC nodes Va, Vb and Vc corresponding to motor winding phases A, B and C of motor 130 as described herein. When operating as rectifier, each three-level converter leg converts an AC voltage applied at one of AC nodes Va, Vb and Vc, to a DC voltage across positive DC node+VDC and negative DC node −VDC.

Switches Tu1, Tu4, Tv1, Tv4, Tw1, and Tw4 are each associated with a diode, Du1, Du4, Dv1, Dv4, Dw1, and Dw4, respectively. Each diode is connected with its cathode coupled to the collector and its anode coupled to the emitter of a switch, to serve as a freewheeling or flyback diode. The system 100 also includes capacitors C1 and C2, connected such that the anode of capacitor C1 is connected to a positive DC line, the cathode of the capacitor C1 is connected to the anode of the capacitor C2, and the cathode of the capacitor C2 is connected to a negative DC voltage line. A center-grounded battery 101 is illustrated connected to the cathode of capacitor C1 and the anode of the capacitor C2. The battery 101 may provide the DC voltage on the positive and negative voltage lines 102 and 103.

Also shown in FIG. 1, the system 100 comprises six switches: Tu2 and Tu3 connected source-to-drain in parallel between the nodes N1 and N2; Tv2 and Tv3 connected source-to-drain in parallel between nodes N1 and N3; and Tw2 and Tw3 connected source-to-drain in parallel between nodes N1 and N4.

When operating as an inverter, a controller (not shown in FIG. 1) applies control signals to switches Tu1-Tu4, Tv1-Tv4, and Tw1-Tw4 to generate AC waveforms at AC nodes Va, Vb and Vc. AC nodes Va, Vb and Vc are coupled to phases A, B, and C of motor 130, which correspond to windings of the motor.

The power conversion system 100 may also be used as a rectifier to convert AC voltage at AC nodes Va, Vb and/or Vc to a DC voltage across the positive DC node 102 and the negative DC node 103.

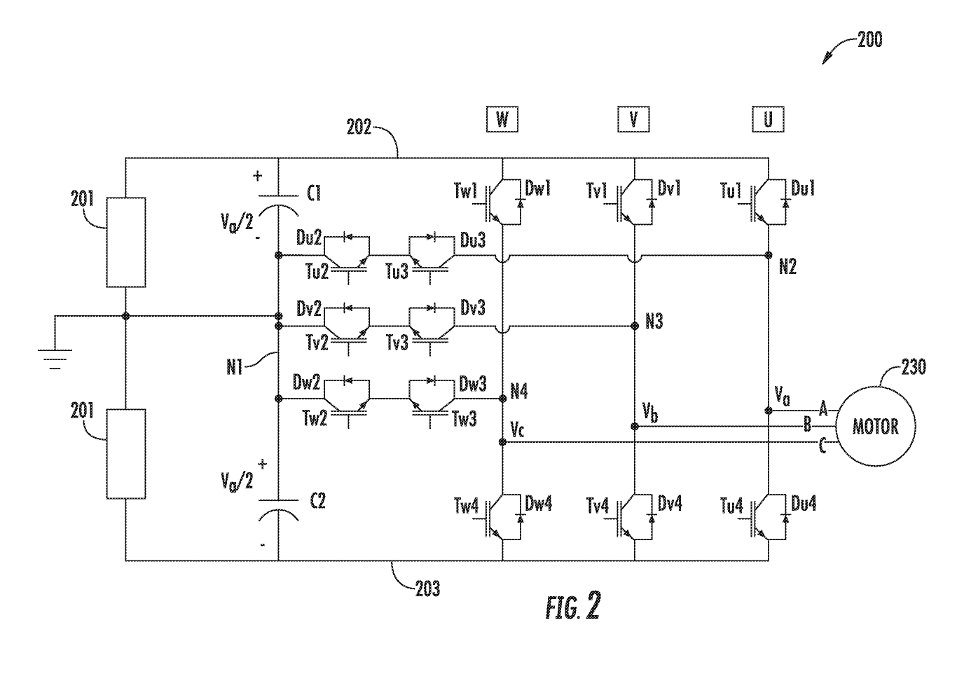

FIG. 2 illustrates a power conversion system 200 according to another embodiment of the invention.

Similar to the system 100 of the embodiment illustrated in FIG. 1, the system 200 depicted in this embodiment uses a neutral point clamped (NPC) topology having three converter legs, indicated generally by reference letters U, V, and W. The system 200 of FIG. 2 may be referred to as a T-type neutral point claims (T-NPC) circuit. Switches Tu1, Tu2, Tu3, and Tu4 provide a first three-level converter leg (U), switches Tv1, Tv2, Tv3, and Tv4 provide a second three-level converter leg (V), and switches Tw1, Tw2, Tw3, and Tw4 provide a third three-level converter leg (W). In one embodiment, switches Tu1-Tu4, Tv1-Tv4, and Tw1-Tw4 are IGBTs, although MOSFETs, IGCT's, or other similar types of high-voltage switches may be utilized without departing from the scope of the invention.

When operating as an inverter, the three-level converter legs U, V, and W respectively provide AC power to AC nodes Va, Vb and Vc corresponding to motor winding phases A, B and C of motor 230 as described herein. When operating as rectifier, each three-level converter leg converts an AC voltage applied at one of AC nodes Va, Vb and Vc, to a DC voltage across positive DC node 202 and negative DC node 203.

Switches Tu1, Tu4, Tv1, Tv4, Tw1, and Tw4 are each associated with a diode, Du1, Du4, Dv1, Dv4, Dw1, and Dw4, respectively. Each diode is connected with its cathode coupled to the collector and its anode coupled to the emitter of a switch, to serve as a freewheeling or flyback diode. The system 200 also includes capacitors C1 and C2, connected such that the anode of capacitor C1 is connected to the positive DC node 202, the cathode of the capacitor C1 is connected to the anode of the capacitor C2, and the cathode of the capacitor C2 is connected to the negative DC node 203. A center-grounded battery 201 is illustrated connected to the cathode of capacitor C1 and the anode of the capacitor C2. The battery 201 may provide the DC voltage on the positive and negative nodes 102 and 103.

Also shown in FIG. 2, the system 200 comprises six diode-switch pairs. The first pair 211 includes switch Tu2 connected in parallel with diode Du2, and the second pair 212 includes switch Tu3 connected in parallel with diode Du3. The first and second pairs are connected in series between node N1 and node N2. The third pair 213 includes switch Tv2 connected in parallel with diode Dv2, and the fourth pair 214 includes switch Tv3 connected in parallel with diode Dv3. The third and fourth pairs are connected in series between node N1 and node N3. The fifth pair 215 includes switch Tw2 connected in parallel with diode Dw2, and the sixth pair 216 includes switch Tw3 connected in parallel with diode Dw3. The fifth and sixth pairs are connected in series between node N1 and node N4.

When operating as an inverter, a controller (not shown in FIG. 2) applies control signals to switches Tu1-Tu4, Tv1-Tv4, and Tw1-Tw4 to generate AC waveforms at AC nodes Va, Vb and Vc. AC nodes Va, Vb and Vc are coupled to phases A, B, and C of motor 130, which correspond to windings of the motor.

The power conversion system 100 may also be used as a rectifier to convert AC voltage at AC nodes Va, Vb and/or Vc to a DC voltage across the positive DC node 202 and the negative DC node 203.

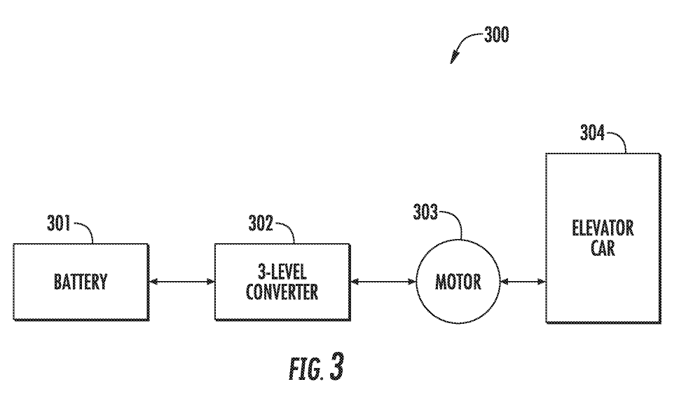

While embodiments of the invention encompass any system, device, or assembly requiring power conversion, in one embodiment the power conversion system is implemented in a battery-powered elevator system. FIG. 3 illustrates a block diagram of a battery-powered elevator system according to an embodiment of the invention. The system 300 includes a battery 301. The battery 301 may be a center-grounded battery, such as the battery 101 of FIG. 1 or the battery 201 of FIG. 2. The elevator system 300 includes a 3-level converter system 302, such as the system 100 illustrated in FIG. 1 or the system 200 illustrated in FIG. 2, between the battery 301 and a motor 303. The motor 303 is connected to an elevator car 304 to move the elevator car 304. In addition, the motor 303 may be configured to generate AC power based on movement of the elevator car 304, such as by the descent of the elevator car 304 to provide regenerative power in the elevator system 300. In such an embodiment, the power provided by the motor 303 based on movement of the elevator car 304 is provided to the three-level converter system 302, where it is converted to DC power and supplied to the battery 301 to charge the battery. The block diagram of FIG. 3 illustrates a basic functional structure of an elevator system 300 according to an embodiment of the invention, but embodiments of the invention are not limited to the illustrated structure. Instead, embodiments encompass any elevator system utilizing a three-level converter.

Technical effects of embodiments of the invention having 3-level power conversion include providing power conversion utilizing lower voltages and less electromagnetic interference compared to conventional power converters, such as half-bus switched power converters.

Embodiments provide benefits over existing designs. The use of a battery center-connected to a ground node means there is no need for a control effort to ensure neutral point stability. As the switches no longer are used to control stability of the neutral point, the system can be operated with minimized switching to achieve lower EMI, to achieve lower acoustic noise from motor and to achieve lower current ripple in motor, and hence less heating. The ability to apply a discontinuous PWM (e.g., 2 out of 3 switching) technique provides further efficiency in power conversion in the inverter, and allows other efficiencies as one degree of freedom in the control can be used for other purposes. The NPC type topology allows use of more common, lower voltage rating devices (<100V). Embodiments are efficient as a charger. A charger design using, for example, the topology of FIG. 2 achieves efficient charging, with lower EMI.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A three-level converter, comprising:
a first converter leg having first switches connected across a positive DC node and a negative DC node;
a second converter leg having second switches connected across the positive DC node and the negative DC node;
a third converter leg having third switches connected across the positive DC node and the negative DC node; and
a battery connected between the positive DC node and the negative DC node, and center-connected to a ground node having a ground potential, each of the first, second, and third converter legs connected to the ground node.

2. The three-level converter of claim 1, further comprising:
first and second capacitors connected in series between the positive DC node and the negative DC node, a connection of a cathode of the first capacitor and the anode of the second capacitor connected to the ground node.

3. The three-level converter of claim 1, wherein the first, second, and third converter legs are arranged with one of a T-type neutral point clamped (T-NPC) and an advanced T-type neutral point clamped (AT-NPC) circuit topology.

4. The three-level converter of claim 1, wherein each of the first, second, and third converter legs comprises first and second transistors connected in series, drain-to-source, between the positive DC node and the negative DC node, and an electrical connection between a drain of the first transistor and a source of the second transistor of each of the first, second, and third converter legs defines an AC voltage node

5. The three-level converter of claim 1,
wherein the first converter leg comprises:
a first transistor and a second transistor connected in series, drain-to-source, between the positive DC node and the negative DC node, an electrical connection between a drain of the first transistor and a source of the second transistor defining a first leg node; and
a third transistor connected in parallel, source-to-drain, with a fourth transistor, such that a first source-to-drain connection is connected to the ground node and a second source-to-drain connection is connected to the first leg node.

6. The three-level converter of claim 5, wherein the second converter leg comprises:
a fifth transistor and a sixth transistor connected in series, drain-to-source, between the positive DC node and the negative DC node, an electrical connection between a drain of the fifth transistor and a source of the sixth transistor defining a second leg node; and
a seventh transistor connected in parallel, source-to-drain, with an eighth transistor, such that a first source-to-drain connection is connected to the ground node and a second source-to-drain connection is connected to the second leg node,
and wherein the third converter leg comprises:
a ninth transistor and a tenth transistor connected in series, drain-to-source, between the positive DC node and the negative DC node, an electrical connection between a drain of the ninth transistor and a source of the tenth transistor defining a third leg node; and
an eleventh transistor connected in parallel, source-to-drain, with a twelfth transistor, such that a first source-to-drain connection is connected to the ground node and a second source-to-drain connection is connected to the third leg node.

7. The three-level converter of claim 1, wherein the first converter leg comprises:
a first transistor and a second transistor connected in series, drain-to-source, between the positive DC node and the negative DC node, an electrical connection between a drain of the first transistor and a source of the second transistor defining a first leg node; and
a first transistor/diode pair including a third transistor connected in parallel, source-to-drain with a first diode, and a second transistor/diode pair including a fourth transistor connected in parallel, source-to-drain, with a second diode, the first transistor/diode pair connected in series with the second transistor/diode pair between the ground node and the first leg node.

8. The three-level converter of claim 7, wherein the second converter leg comprises:
a fifth transistor and a sixth transistor connected in series, drain-to-source, between the positive DC node and the negative DC node, an electrical connection between a drain of the fifth transistor and a source of the sixth transistor defining a second leg node; and
a third transistor/diode pair including a seventh transistor connected in parallel, source-to-drain with a third diode, and a fourth transistor/diode pair including an eighth transistor connected in parallel, source-to-drain, with a fourth diode, the third transistor/diode pair connected in series with the fourth transistor/diode pair between the ground node and the second leg node, and
wherein the third converter leg comprises:
a ninth transistor and a tenth transistor connected in series, drain-to-source, between the positive DC node and the negative DC node, an electrical connection between a drain of the ninth transistor and a source of the tenth transistor defining a third leg node; and
a fifth transistor/diode pair including an eleventh transistor connected in parallel, source-to-drain with a fifth diode, and a sixth transistor/diode pair including a twelfth transistor connected in parallel, source-to-drain, with a sixth diode, the fifth transistor/diode pair connected in series with the sixth transistor/diode pair between the ground node and the third leg node.

9. A power conversion system, comprising:
an AC power device configured to perform one of receiving AC power to operate the AC power device or generating AC power; and
a three-level converter connected to the AC power device, the three-level converter comprising:
a first converter leg having first switches connected across a positive DC node and a negative DC node;
a second converter leg having second switches connected across the positive DC node and the negative DC node;
a third converter leg having third switches connected across the positive DC node and the negative DC node, the first, second, and third converter legs connected to the AC power device to perform one of providing AC power to the AC power device and receiving AC power from the AC power device; and
a battery connected between the positive DC node and the negative DC node, and center-connected to a ground node having a ground potential, each of the first, second, and third converter legs connected to the ground node.

10. The power conversion system of claim 9, further comprising:
first and second capacitors connected in series between the positive DC node the a negative DC node, a connection of a cathode of the first capacitor and the anode of the second capacitor connected to the ground node.

11. The power conversion system of claim 9, wherein the first, second, and third converter legs are arranged with one of a T-type neutral point clamped (T-NPC) and an advanced T-type neutral point clamped (AT-NPC) circuit topology.

12. The power conversion system of claim 9, wherein each of the first, second, and third converter legs comprises first and second transistors connected in series, drain-to-source, between the positive DC node and the negative DC node, and an electrical connection between a drain of the first transistor and a source of the second transistor of each of the first, second, and third converter legs defines an AC voltage node.

13. The power conversion system of claim 9, wherein the first converter leg comprises:
a first transistor and a second transistor connected in series, drain-to-source, between the positive DC node and the negative DC node, an electrical connection between a drain of the first transistor and a source of the second transistor defining a first leg node; and
a third transistor connected in parallel, source-to-drain, with a fourth transistor, such that a first source-to-drain connection is connected to the ground node and a second source-to-drain connection is connected to the first leg node.

14. The power conversion system of claim 13, wherein the second converter leg comprises:
a fifth transistor and a sixth transistor connected in series, drain-to-source, between the positive DC node and the negative DC node, an electrical connection between a drain of the fifth transistor and a source of the sixth transistor defining a second leg node; and
a seventh transistor connected in parallel, source-to-drain, with an eighth transistor, such that a first source-to-drain connection is connected to the ground node and a second source-to-drain connection is connected to the second leg node,
and wherein the third converter leg comprises:
a ninth transistor and a tenth transistor connected in series, drain-to-source, between the positive DC node and the negative DC node, an electrical connection between a drain of the ninth transistor and a source of the tenth transistor defining a third leg node; and
an eleventh transistor connected in parallel, source-to-drain, with a twelfth transistor, such that a first source-to-drain connection is connected to the ground node and a second source-to-drain connection is connected to the third leg node.

15. The power conversion system of claim 9, wherein the first converter leg comprises:
a first transistor and a second transistor connected in series, drain-to-source, between the positive DC node and the negative DC node, an electrical connection between a drain of the first transistor and a source of the second transistor defining a first leg node; and
a first transistor/diode pair including a third transistor connected in parallel, source-to-drain with a first diode, and a second transistor/diode pair including a fourth transistor connected in parallel, source-to-drain, with a second diode, the first transistor/diode pair connected in series with the second transistor/diode pair between the ground node and the first leg node.

16. The power conversion system of claim 15, wherein the second converter leg comprises:
a fifth transistor and a sixth transistor connected in series, drain-to-source, between the positive DC node and the negative DC node, an electrical connection between a drain of the fifth transistor and a source of the sixth transistor defining a second leg node; and
a third transistor/diode pair including a seventh transistor connected in parallel, source-to-drain with a third diode, and a fourth transistor/diode pair including an eighth transistor connected in parallel, source-to-drain, with a fourth diode, the third transistor/diode pair connected in series with the fourth transistor/diode pair between the ground node and the second leg node, and
wherein the third converter leg comprises:
a ninth transistor and a tenth transistor connected in series, drain-to-source, between the positive DC node and the negative DC node, an electrical connection between a drain of the ninth transistor and a source of the tenth transistor defining a third leg node; and
a fifth transistor/diode pair including an eleventh transistor connected in parallel, source-to-drain with a fifth diode, and a sixth transistor/diode pair including a twelfth transistor connected in parallel, source-to-drain, with a sixth diode, the fifth transistor/diode pair connected in series with the sixth transistor/diode pair between the ground node and the third leg node.

17. The power conversion system of claim 9, wherein the AC power device is an AC motor that operates based on receiving AC power from the three-level converter.

18. An elevator system, comprising:
an elevator car;
a motor configured to move the elevator car;
a battery for supplying power to the motor; and
a three-level converter electrically connected between the battery and the motor to convert DC power from the battery into AC power to run the motor, the three-level converter comprising:
a first converter leg having first switches connected across a positive DC node and a negative DC node;
a second converter leg having third switches connected across the positive DC node and the negative DC node;
a third converter leg having third switches connected across the positive DC node and the negative DC node,
wherein the battery is connected between the positive DC node and the negative DC node, and center-connected to a ground node having a ground potential, each of the first, second, and third converter legs connected to the ground node.

19. The elevator system of claim 18, wherein the three-level converter further comprises:
first and second capacitors connected in series between the positive DC node and the negative DC node, a connection of a cathode of the first capacitor and the anode of the second capacitor connected to the ground node.

20. The elevator system of claim 18, wherein the first, second, and third converter legs are arranged with one of a T-type neutral point clamped (T-NPC) and an advanced T-type neutral point clamped (AT-NPC) circuit topology.
